(19) United States
(12) Patent Application Publication
(10) Pub. No.: US 2023/0182368 A1
(43) Pub. Date: Jun. 15, 2023

(54) SEAL PIN FOR CONTAINER FORMING AND FILLING

(71) Applicant: LIQUIFORM GROUP LLC, Saline, MI (US)

(72) Inventors: Gregory CARPENTER, Ann Arbor, MI (US); Richard Steih, Jackson, MI (US)

(21) Appl. No.: 17/921,942

(22) PCT Filed: Apr. 29, 2020
(86) PCT No.: PCT/US2020/030439

§ 371 Date: Oct. 27, 2022

(51) Int. Cl. B29C 49/58; B65B 3/02; B65B 3/04; B29C 49/46

(52) U.S. Cl. CPC B29C 49/58; B29C 49/46; B65B 3/04; B65B 3/022; B29C 2049/4664; B29L 2031/712

(57) ABSTRACT

A seal pin assembly for a forming and filling head configured to inject a product into a thermoplastic preform for simultaneously forming a container from the thermoplastic preform and filling the container with the product. The seal pin assembly includes a seal pin movable within the forming and filling head towards and away from a nozzle of the forming and filling head. The nozzle is configured to cooperate with the thermoplastic preform. A vortex generating member is mounted to the seal pin and configured to convert a stream of the product into a vortex as the product flows across the vortex generating member and out through the nozzle.

### FIELD

The present disclosure relates to a seal pin assembly for a forming and filling head configured to inject a product into a thermoplastic preform for simultaneously forming a container from the thermoplastic preform and filling the container with the product.

### BACKGROUND

This section provides background information related to the present disclosure, which is not necessarily prior art.

Polymeric containers are used to store various types of food and beverages. Such containers are typically formed from a preform using various processes. One such process involves simultaneously forming the container from a preform and filling the container with any suitable product. This process is commonly referred to as Liquiform®. To simultaneously form and fill the container, a forming/filling head is placed into cooperation with a finish of the preform.

While current Liquiform® heads are suitable for their intended use, they are subject to improvement. For example, flow through existing heads may become “sided” (i.e., non-conical), depending on how the liquid enters the head and how flow drags around the stretch rod. When forming high-density polyethylene containers, gates have been seen to drift off-center to a repeatable container side (with respect to the mold). Also, with existing Liquiform® heads excessive material bubbling may occur during forming/filling, and shoulder areas of the container may not properly form. The present disclosure advantageously provides for an improved seal pin assembly that address these issues. One skilled in the art will appreciate that the present disclosure provides numerous additional advantages and unexpected results as well.

### SUMMARY

This section provides a general summary of the disclosure, and is not a comprehensive disclosure of its full scope or all of its features.

The present disclosure includes a seal pin assembly for a forming and filling head configured to inject a product into a thermoplastic preform for simultaneously forming a container from the thermoplastic preform and filling the container with the product. The seal pin assembly includes a seal pin movable within the forming and filling head towards and away from a nozzle of the forming and filling head. The nozzle is configured to cooperate with the thermoplastic preform. A vortex generating member is mounted to the seal pin and configured to convert a stream of the product into a vortex as the product flows across the vortex generating member and out through the nozzle.

The present disclosure further includes a method for simultaneously forming a container from a thermoplastic preform and filling the container with a product dispersed from a nozzle of a forming and filling head including a seal pin assembly. The method includes converting a stream of the product into a vortex by directing the stream of the product across a vortex generating member mounted to a seal pin of the seal pin assembly such that the product exits the nozzle and flows into the preform as a uniform, conical stream having a centrifugal motion.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a cross-sectional view of seal pin assembly in accordance with the present disclosure including in a forming/filling head configured to inject product into a preform to simultaneously form a container from the preform and fill the container with the product;

FIG. 2 is a perspective view of FIG. 1;

FIG. 3A is a side view of a vortex generating member in accordance with the present disclosure configured to convert a stream of the product into a vortex as the product flows across the vortex generating member;

FIG. 3B is a perspective view of the vortex generating member of FIG. 3A; and

FIG. 3C is a top view of the vortex generating member of FIG. 3A.

Corresponding reference numerals indicate corresponding parts throughout the several views of the drawings.

### DETAILED DESCRIPTION

Example embodiments will now be described more fully with reference to the accompanying drawings.

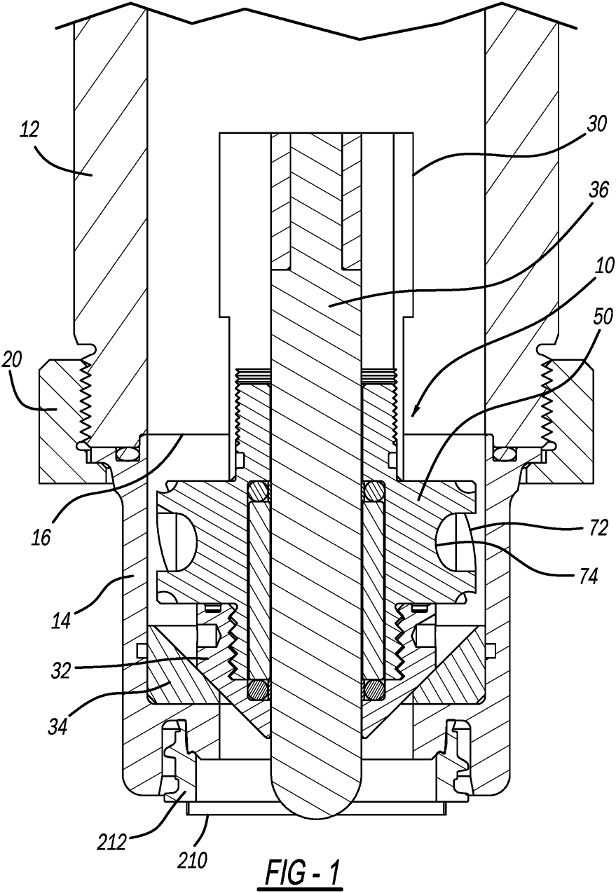

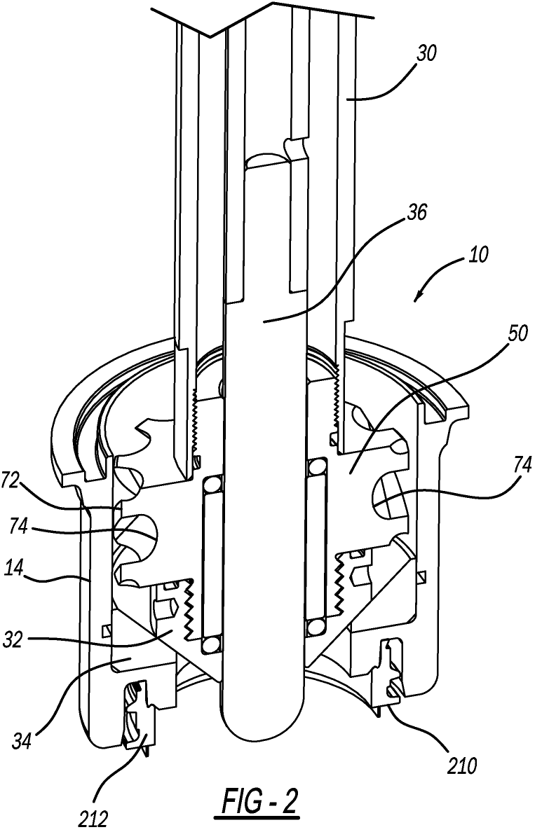

FIGS. 1 and 2 illustrate a seal pin assembly 10 in accordance with the present disclosure for use with any suitable machine head, such as forming and filling head 12 for simultaneously forming and filling a polymeric container from a container preform 210. The preform 210 and the resulting container can be formed of any suitable polymeric material, such as polyethylene terephthalate (PET), low-density polyethylene (LDPE), high-density polyethylene (HDPE), polypropylene (PP), polystyrene, and the like, for example. The forming and filling head 12 is configured for use with any suitable Liquiform® machine, for example, such as described in the following U.S. Pats., each of which is incorporated herein by reference: 7,914,726; 8,017,064; 8,435,026; and 8,573,964.

A nozzle 14 is secured to an outlet 16 of the forming and filling head 12 in any suitable manner, such as with a coupling member 20. With the nozzle 14 secured to the head 12, and a finish 212 of the preform 210 sealed to the nozzle 14, any suitable product can be injected from the head 12 into the preform 210 by way of the nozzle 14 to simultaneously form a container from the preform 210 and fill the container with the product. Suitable products include, but are not limited to, water, sports drinks, juice, sauces, any suitable foodstuffs, etc.

The seal pin assembly 10 generally includes a seal pin 30, which is moveable within the forming and filling head 12 to open and close the nozzle 14. In a closed position, a seal 32 of the seal pin assembly 10 contacts and seals against a nozzle seal 34 of the nozzle to prevent product from exiting the nozzle 14. In an open position, the seal 32 is spaced apart from the nozzle seal 34 to allow fluid to flow through the nozzle 14 and into the preform 210. To facilitate forming of the container, a stretch rod 36 may be extended through the seal 32 and the nozzle 14, and into the preform 210.

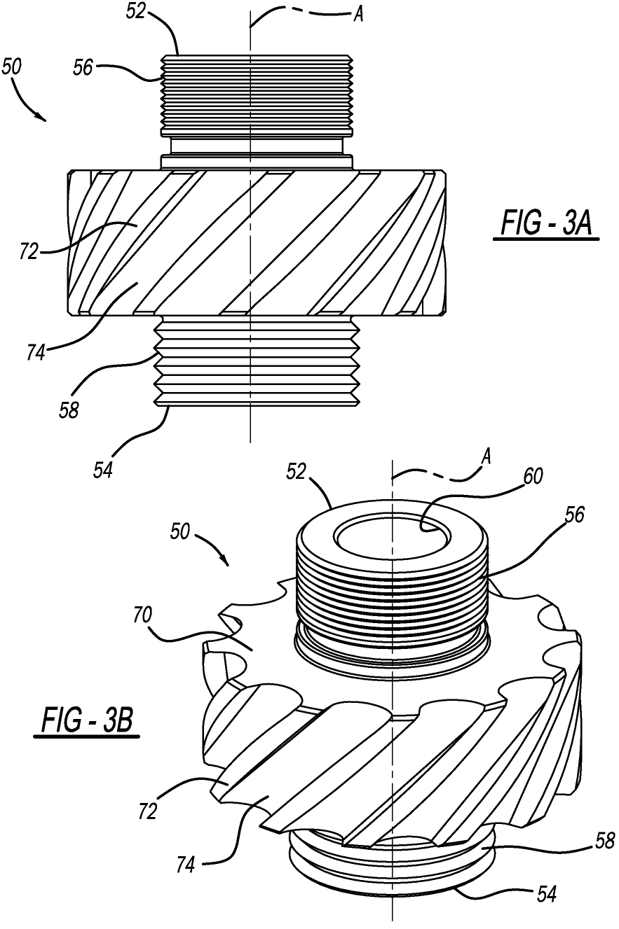

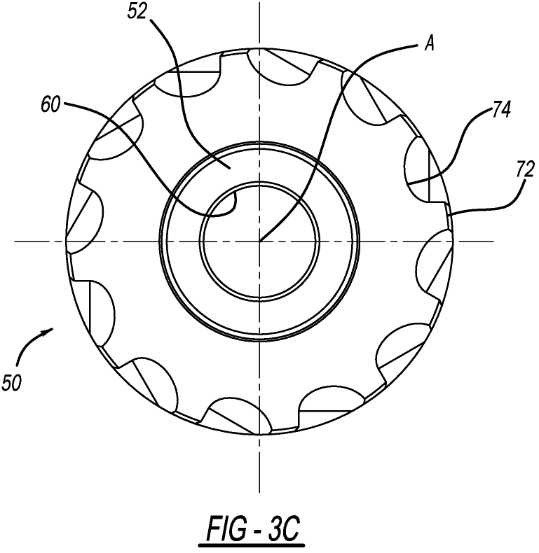

With continued reference to FIGS. 1 and 2, and additional reference to FIGS. 3A, 3B, and 3C, the seal pin assembly 10 further includes a vortex generating member 50, which may be coupled to a distal end of the seal pin 30. The seal 32 is coupled to the vortex generating member 50. The vortex generating member 50 generally includes a proximal end 52 and a distal end 54, which is opposite to the proximal end 52. At the proximal end 52 is an upper coupling 56, which may include any suitable coupling members configured to couple with the seal pin 30. In the example illustrated, the upper coupling 56 includes threads configured to cooperate with threads at a distal end of the seal pin 30. At the distal end 54 of the vortex generating member 50 is a lower coupling 58, which may be configured in any suitable manner to connect the seal 32 to the distal end 54. In the example illustrated, the lower coupling 58 includes a plurality of threads configured to cooperate with threads of the seal 32. The vortex generating member 50 defines a bore 60 extending through the vortex generating member 50 along an axis A thereof extending from the proximal end 52 to the distal end 54. The bore 60 is sized and shaped to accommodate the stretch rod 36.

The vortex generating member 50 further includes a body 70 between the upper coupling 56 and the lower coupling 58. The body 70 includes a plurality of vanes extending from an outer periphery of the body 70 away from the axis A. The vanes 72 define channels 74. Specifically, each one of the channels 74 is defined between vanes 72 that are directly adjacent to one another. The vanes 72 extend in a helical manner, and the channels 74 are helical channels. The vanes 72 extend outward to an inner surface of the nozzle 14 such that the vanes 72 abut, or nearly abut, the inner surface of the nozzle 14.

Product flowing through the filling head 12 and the nozzle 14 flows through the channels 74. Because the channels 74 are helical, a stream of the product is converted from a generally linearly flow into a vortex. As a result, the product exits the nozzle 14 as a uniform, conical stream having a centrifugal motion.

The centrifugal motion of the product advantageously generates a density gradient where bubbles of the product move towards a center of the container after the container has been formed from the preform 210. The bubbles coalesce, rise to a surface of the product, and disperse. As a result, a container formed and filled with product that has flowed through the channels 74 of the vortex generating member 50 will have fewer bubbles as compared to product filled with a filling head that does not include the vortex generating member 50. The bubbles quickly rise to the surface and disperse because, in part, there is little or no contact/adherence to a sidewall of the container and no isolation in suspension of the bubbles.

The vortex/centrifugal flow of product within the formed container continues for about 15-20 seconds post-formation of the container, at least with respect to products having a viscosity similar to water. During this time, the bubbles move from the sidewall of the container to the center of the container due to centrifugal forces creating a density gradient. As the vortex flow slows, the bubbles combine and rise to the surface of the product as a single mass. As a result, duration of the bubbles is less as compared to containers that are filled with filling heads that do not include the vortex generating member 50.

With respect to filling heads that do not include the vortex generating member 50, an aneurism often forms close to a gate, and a shoulder of the container is the last portion to form. In contrast, product that has passed through the helical channels 74 of the vortex generating member 50 is directed in the “hoop” direction after the product flows out of the nozzle 14 and into the preform 210. As a result, the aneurism is closer to the shoulder of the container, which results in improved formation of the shoulder as compared to containers that are formed/filled with filling heads that do not include the vortex generating member 50.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A seal pin assembly for a forming and filling head configured to inject a product into a thermoplastic preform for simultaneously forming a container from the thermoplastic preform and filling the container with the product, the seal pin assembly comprising:
a seal pin movable within the forming and filling head towards and away from a nozzle of the forming and filling head, the nozzle configured to cooperate with the thermoplastic preform; and
a vortex generating member mounted to the seal pin and configured to convert a stream of the product into a vortex as the product flows across the vortex generating member and out through the nozzle.

2. The seal pin assembly of claim 1, further comprising a seal mounted to the seal pin downstream of the vortex generating member relative to flow of the product through the filling head, the seal configured to seal against the nozzle.

3. The seal pin assembly of claim 1, wherein the vortex generating member defines an opening at a center thereof configured to receive a stretch rod.

4. The seal pin assembly of claim 1, wherein the vortex generating member includes threads configured to cooperate with the seal pin to connect the vortex generating member to the seal pin.

5. The seal pin assembly of claim 1, wherein the vortex generating member includes a plurality of vanes extending about an outer surface of the vortex generating member.

6. The seal pin assembly of claim 5, wherein the plurality of vanes define channels therebetween through which the product flows.

7. The seal pin assembly of claim 6, wherein the plurality of vanes and the plurality of channels are helical.

8. The seal pin assembly of claim 7, wherein the plurality of channels are configured such that product that flows through the plurality of channels exits the nozzle as a uniform, conical stream.

9. The seal pin assembly of claim 8, wherein the plurality of channels are configured such that product that flows through the plurality of channels exits the nozzle with a centrifugal motion.

10. The seal pin assembly of claim 9, wherein as the product exits the nozzle and flows into the container, centrifugal motion of the product generates a density gradient where bubbles of the product move towards a center of the container after the container has been formed from the preform, the bubbles coalesce, rise to a surface of the product, and disperse.

11. The seal pin assembly of claim 9, wherein as the product exits the nozzle and flows into the container, an aneurism forms at a shoulder of the container.

12. A method for simultaneously forming a container from a thermoplastic preform and filling the container with a product dispersed from a nozzle of a forming and filling head including a seal pin assembly, the method comprising:
converting a stream of the product into a vortex by directing the stream of the product across a vortex generating member mounted to a seal pin of the seal pin assembly such that the product exits the nozzle and flows into the preform as a uniform, conical stream having a centrifugal motion.

13. The method of claim 12, wherein the product is directed through channels of the vortex generating member defined by vanes of the vortex generating member.

14. The method of claim 12, further comprising moving a stretch rod through a center opening defined by the vortex generating member.

15. The method of claim 12, further comprising moving a seal of the seal pin assembly into cooperation with a nozzle seal of the nozzle to prevent product from flowing out of the nozzle, and moving the seal out of cooperation with the nozzle seal to allow product to flow out of the nozzle and into the preform.

16. The method of claim 12, wherein as the product exits the nozzle and flows into the container, centrifugal motion of the product generates a density gradient where bubbles of the product move towards a center of the container after the container has been formed from the preform, the bubbles coalesce, rise to a surface of the product, and disperse.

17. The method of claim 12, wherein as the product exits the nozzle and flows into the container, an aneurism forms at a shoulder of the container.
